(19) United States
(12) Patent Application Publication
(10) Pub. No.: US 2026/0008258 A1
(43) Pub. Date: Jan. 8, 2026

(54) PACKAGING WITH SCREEN PROTECTOR INSTALLATION TOOL

(71) Applicant: 1Lss, Inc., Los Angeles, CA (US)

(72) Inventors: Fernando Mora, Reseda, CA (US); Alejandro Baca, Sherman Oaks, CA (US); Mydul R. Islam, Los Angeles, CA (US); Kevin H. Vuong, Baldwin Park, CA (US)

(73) Assignee: 1Lss, Inc., Los Angeles, CA (US)

(21) Appl. No.: 19/253,207

(22) Filed: Jun. 27, 2025

Related U.S. Application Data
(60) Provisional application No. 63/667,077, filed on Jul. 2, 2024.

(51) Int. Cl. B32B 37/00

(52) U.S. Cl. CPC B32B 37/0046; B32B 2457/20

(57) ABSTRACT

A packaging for a case for a mobile device. A housing has a first portion and a second portion. The first portion and second portion collectively interact to define an internal volume sufficient to contain the case. A set of stops disposed on the first portion define an alignment area dimensioned to snugly retain the mobile device. An adhesive screen protector for the mobile device is disposed within the second portion to be in alignment with a screen of the mobile device when the mobile device is positioned in the alignment area and the first portion and second portion are in a closed configuration.

### CROSS-REFERENCE TO RELATED APPLICATIONS

This application claims the benefit of priority under 35 U.S.C. § 119(e) of U.S. Provisional Patent Application No. 63/667,077, entitled Packaging for Mobile Device Case with Integral Screen Protector Alignment, filed on Jul. 2, 2024, the content of which is incorporated herein by reference in its entirety for all purposes.

### BACKGROUND

### Technological Field

Embodiments of the invention relate to a packaging. More specifically, embodiments of the invention relate to packaging for a mobile device case with integrated screen protector installation features.

### Background

Mobile devices such as smart phones are ubiquitous in today's technological landscape. Various forms of screen protectors exist to reduce the risk of damage to the screen of the mobile device. One common screen protector is a thin film adhesive backed material that overlies the screen. Unfortunately, these are often difficult to properly align and when misaligned tend to look bad and detach from the screen prematurely. What is needed is a way to ensure proper alignment while permitting easy installation of thin film screen protectors.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1A is a perspective view of the packaging of one embodiment of the invention in an open orientation.

FIG. 1B is a cross-sectional view of a portion of the second portion of the packaging with screen protector according to one embodiment of the invention.

FIG. 1C is a perspective view of the second portion of the packaging without the screen protector.

FIG. 2 is a perspective view of a first portion of the packaging.

FIG. 3 is a plan view of the first portion of the packaging with a mobile device case disposed therein.

FIG. 4 is perspective view of the first portion of the packaging with a mobile device disposed in an alignment area and the mobile device case shown in phantom lines.

FIG. 5 is a plan view of the first portion of the packaging with the mobile device disposed in an alignment area.

FIG. 6 is a perspective view of the packaging with the mobile device in the alignment area and a backing tab unfolded to extend through an extraction slot.

FIG. 7 is a perspective view of the packaging in a closed orientation with the backing tab extending through the extraction slot.

FIG. 8 is a view of a kit according to one embodiment of the invention.

FIG. 9 is a flow diagram of installation of a screen protector according to one embodiment of the invention.

### DETAILED DESCRIPTION

Embodiments of the invention provide a packaging for a mobile device case having integral screen protector installation features. The packaging in which the case may be shipped has features to align a corresponding mobile device such that a screen protector disposed within the packaging will be aligned with the screen of the device to ensure correct alignment and easy installation of the screen protector on the mobile device.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The term “set”, as used herein, means one or more and is deemed to exclude the empty set.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

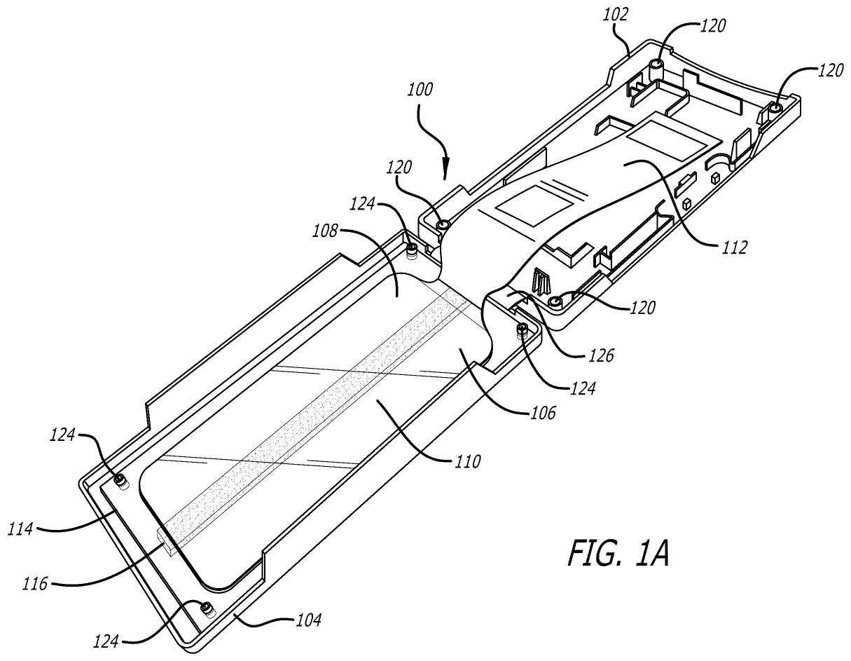

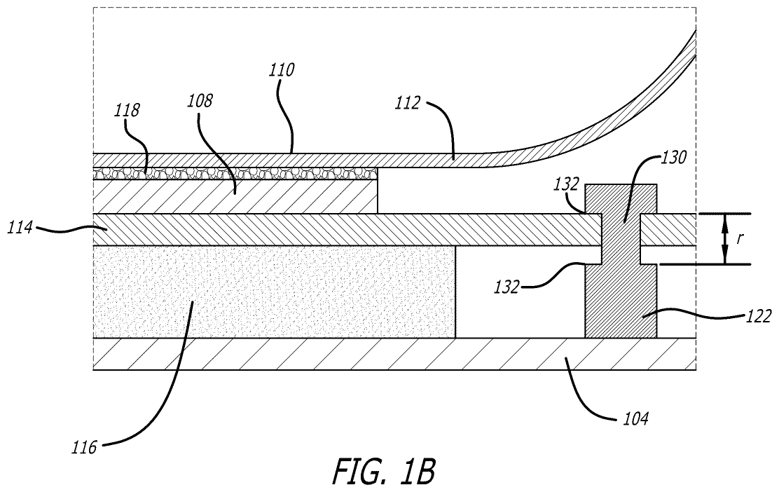

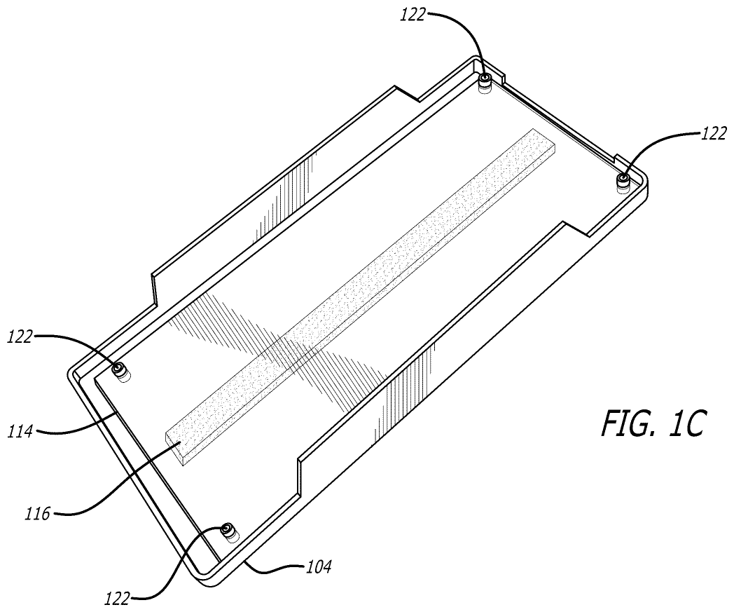

FIG. 1A is a perspective view of the packaging of one embodiment of the invention in an open orientation. In this embodiment, the packaging 100 is designed to hold a case for a mobile device such as a smart phone for sale and/or shipment. A first portion 102 of the packaging 100 is coupled to a second portion 104 by a living hinge 126. As such the first portion 102 and the second portion 104, in a closed orientation, collectively define a volume sufficient to contain the case.

In one embodiment, the first portion 102, second portion 104 and living hinge 126 are formed as an integral unit by injection molding. In some embodiments, synthetic materials such as polyoxymethylene (POM) polycarbonate, acrylonitrile butadiene styrene (ABS) or other plastics may be used to form the packaging 100. As shown first portion 102 is effectively the base of packaging 100 and second portion 104 is the lid. A first set of alignment posts 120 may be formed on the first portion 102 to align with a second set of alignment posts 122 formed on the second portion 104. In one embodiment, the first and second set of alignment posts form a male/female interconnection when the packaging 100 is closed. This interconnection assures precise x-y alignment of the first portion 102 and the second portion 104. In some embodiments, the female posts are on the first portion 102 and the male posts are on the second portion. In other embodiments, the male posts may be on the first portion 102 and the female post on the second portion 104.

In one embodiment, a screen protector 106 is disposed within the second portion 104. Screen protector 106 includes a substantially transparent thin film 108 with an adhesive layer and a non-adhesive backing 110 that extend into a tab 112. In some embodiments both the backing 110 and the thin film 108 are substantially transparent. In one embodiment, a carrier 114 for the screen protector 106 may be slidably coupled to the alignment posts 122 in the second portion. Generally, the carrier 114 may be a substantially planar sheet of synthetics material. In some embodiments it may be transparent. The screen protector 106 is coupled to the carrier 114 to move with the carrier 114 as it slides along the alignment posts 122.

In some embodiments, a resilient member 116, may be coupled to the second portion 104 to be underly at least a portion of the carrier 114. The resilient member 116 biases the carrier 114 (and therefore the thin film 108) towards the first portion in a z direction. Compression of the resilient member 116 allows the carrier to move in a −z direction.

Presale or during shipping the tab is folded to reside in the second portion 104 overlying the screen protectorn106. For installation, as described in more detail below, the tab is unfolded to extend through an extraction slot in the packaging 100.

While the shown embodiment has a clam shell configuration. Other embodiments may have a nested configuration where the first portion nests within the second portion or vice versa.

FIG. 1B is a cross-sectional view of a portion of the second portion (lid) of the packaging with screen protector according to one embodiment of the invention. In this view, the layers of the screen protector 106 are illustrated. The resilient member 116 is coupled to an inner surface of the second portion 104. In some embodiments, the resilient member 116 may be an elastomeric foam or the like. In other embodiments, one or mor springs may resiliently bias the carrier 114. In some embodiments it may be coupled to the second portion 104 by an aggressive adhesive. In other embodiments it may be coupled to the second portion 104 by heat welding or any other suitable conventional method.

The carrier 114 abuts the resilient member 116 to be biased by the resilient member 116 in a z direction (towards the first portion 102). While we refer to this as the positive z direction herein, that is for convenience of description only. The carrier 114 is coupled about a thin region, neck 130 of alignment posts 122 so that movement of the carrier along the post 122 is constrained to a range r defined by the upper and lower bounds, shoulders 132 of the neck 130. The transparent film 108 of the screen protector 106 rides on the carrier 114 to move therewith. An adhesive layer 118 is disposed on the film 108 and serves as the coupling mechanism to allow the film 108 to attach to the mobile device as described in further detail below. A non-adhesive backing 110 releasably couples to the adhesive layer 118 to prevent unintentional adhesion until the backing 110 is removed. Backing 110 extends into a pull tab 112 to facilitate removal as described below.

FIG. 1C is a perspective view of the second portion of the packaging without the screen protector. In this view, the carrier 114 can be seen coupled to all four alignment posts 122 in second portion 104. The resilient member 116 underlies the carrier 114 and biases the carrier 114 up the posts 122 (in the direction of the first portion (not shown)).

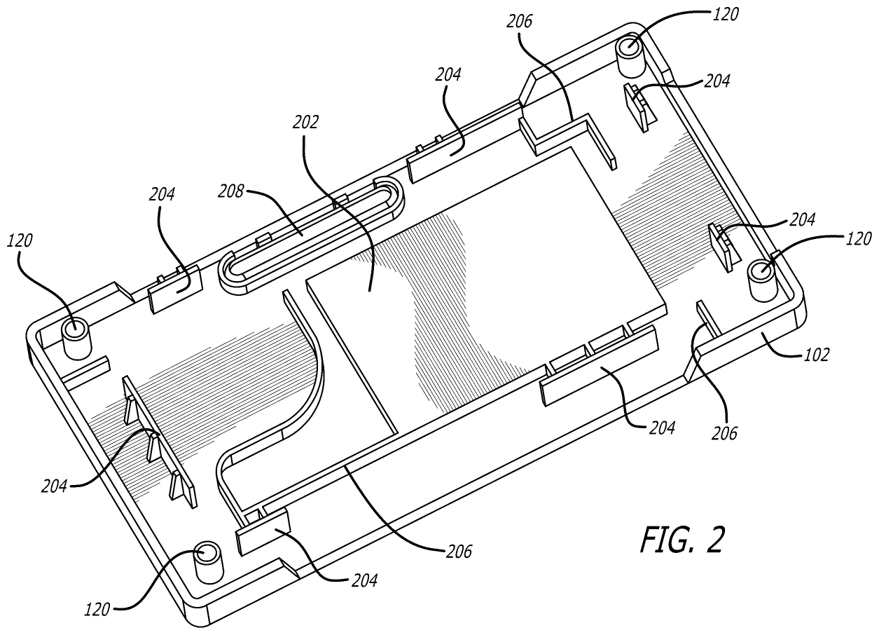

FIG. 2 is a perspective view of a first portion of the packaging. First portion 102 may be formed to have a set of stops 204 that collectively define an alignment area 202 that is dimensioned to snugly fit a desired mobile device. As used herein, snugly fit is deemed to mean that a mobile device is substantially unmovable in an x and a y direction. A set of z-features 204 may be formed as part of first portion 102. The z-features 204 assure that the mobile device snugly residing in the alignment area will have a known z position within the first portion 102. In this way, the resilient member (not shown in this figure) can be assured to cause the screen protector to contact the screen of the device when the package is closed with the device inside. In some embodiments an accessory recess 206 may be molded at part of first portion 102. The dimensions of accessory recess are driven by the accessory to be contained, positioning of the alignment area 202 and the height of the z-features 204. In some embodiments, the walls defining the recess 206 are a same heigh as the z-features 204 effectively becoming an additional z-feature within the alignment area 202.

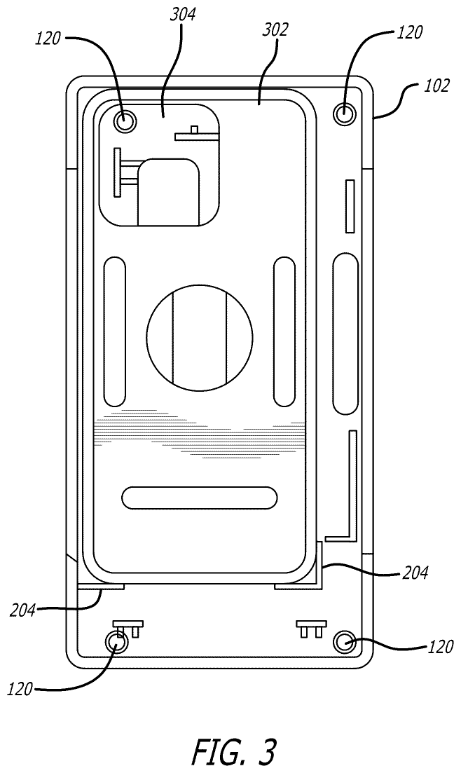

FIG. 3 is a plan view of the first portion of the packaging with a mobile device case disposed therein. In one embodiment, mobile device case 302 resides in first portion 102 for sale and shipping. Case 302 nests between a subset of z-features 204 that constrain its movement with the packaging. The position of the case 302 and its voids, such as lens void 304, ensure that alignment posts 120 are exposed to mate with their counterpart alignment posts of the second portion (not shown).

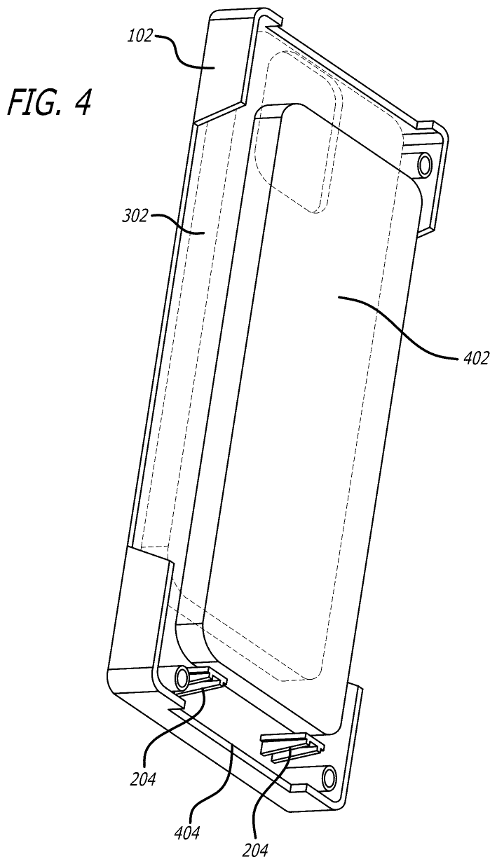

FIG. 4 is perspective view of the first portion of the packaging with a mobile device disposed in an alignment area and the mobile device case shown in phantom lines. This view shows the relative position of the device case 302 in its shipping orientation relative to one possible embodiment of the alignment area 202 with the mobile device 402. In the shown embodiment, the alignment area is displaced from the area where the case 302 (shown in phantom lines) would reside for shipping. In some embodiments, first portion 102 may define all or part of an extraction slot 404 through which the backing of the screen protector can be removed.

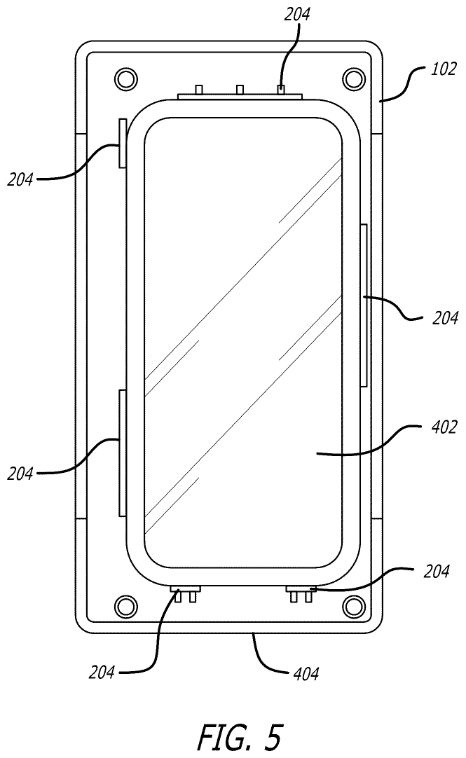

FIG. 5 is a plan view of the first portion of the packaging with the mobile device disposed in an alignment area. In this view the set of stops 204 can be seen defining an alignment area into which mobile device 402 snugly fits. In some embodiments, extraction slot 404 is defined in the end of first portion 102 proximate to a top of mobile device 402 when it is correctly positioned in the alignment area.

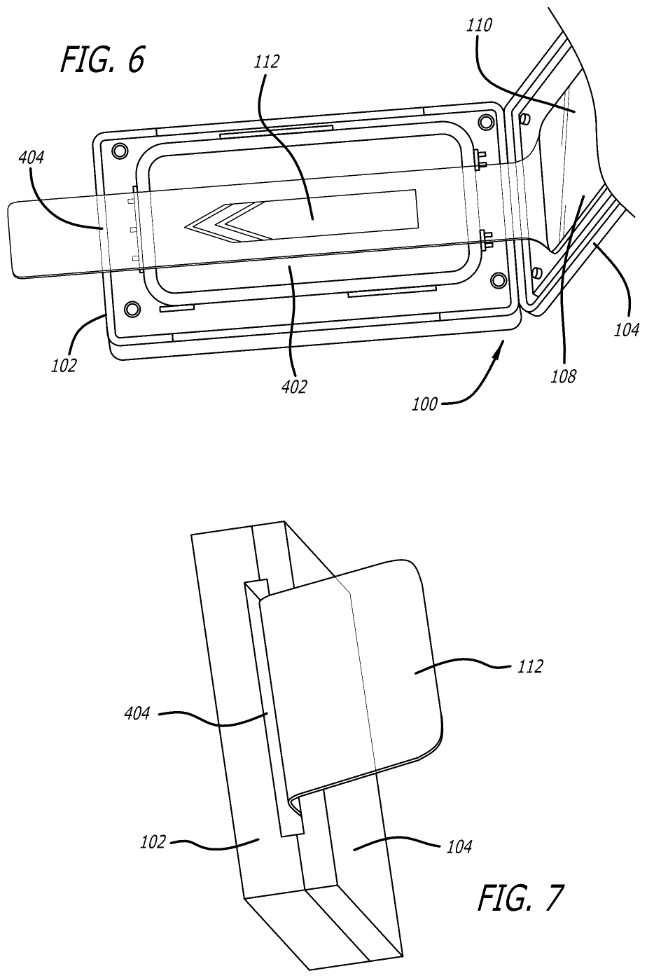

FIG. 6 is a perspective view of the packaging with the mobile device in the alignment area and a backing tab unfolded to extend through an extraction slot. Packaging 100 is shown in an open orientation. Mobile device 402 resided in the alignment area of first portion 102 and is maintained at a known height by z-feature that cannot be seen in this figure. Pull tab 112 is unfolded to extend through extraction slot 404 once the packaging is closed. Backing 110 and transparent film 108 are positioned in the second portion 104 so that the transparent film will be precisely aligned with the alignment area once the packaging is closed.

FIG. 7 is a perspective view of the packaging in a closed orientation with the backing tab extending through the extraction slot. Tab 112 extends through extraction slot 404 to allow a user to pull the tab 112 to remove the backing. As shown in this embodiment, extraction slot is partially defined by first portion 102 and partially defined by second portion 104. In other embodiments, the entire extraction slot 404 may be define by either of the first portion 102 or the second portion 104. When a user pulls the tab 112, what happens internally to the package is the backing releases from the adhesive on the transparent film exposing the adhesive to the screen of the mobile device within the packaging. The resilient member forces the carrier towards the screen ensuring contact between the adhesive and the screen. The transparent film is thereby affixed to the screen in the precise alignment dictated by the packaging.

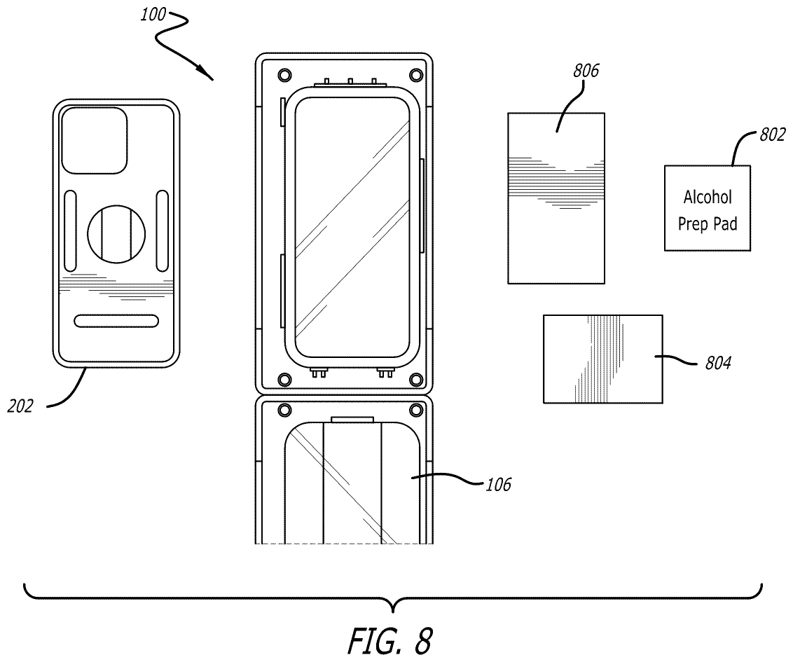

FIG. 8 is a view of a kit according to one embodiment of the invention. A packaging 100 hold the case 302 for a mobile device. The packaging 100 also includes one or more accessories to ensure proper installation of the screen protector 106 that comes as part of the kit. Accessories may include an alcohol pad 802 and/or a sticker 806 and/or a microfiber cloth 804. These accessories help ensure the screen of the mobile device (not part of the kit) is prepared to receive the screen protector 106. In some embodiments, more than one of each accessory type may be provided.

In some embodiments, either the packaging alone or the kit, may permit reuse. That is aftermarket screen protectors may be purchased and installed on the device to for example replace a screen protector that has become damaged or otherwise needs replacement. In such embodiments, an aftermarket screen protectors can be couple to the carrier to be in alignment with the alignment area. Additional accessories may be used with such aftermarket products.

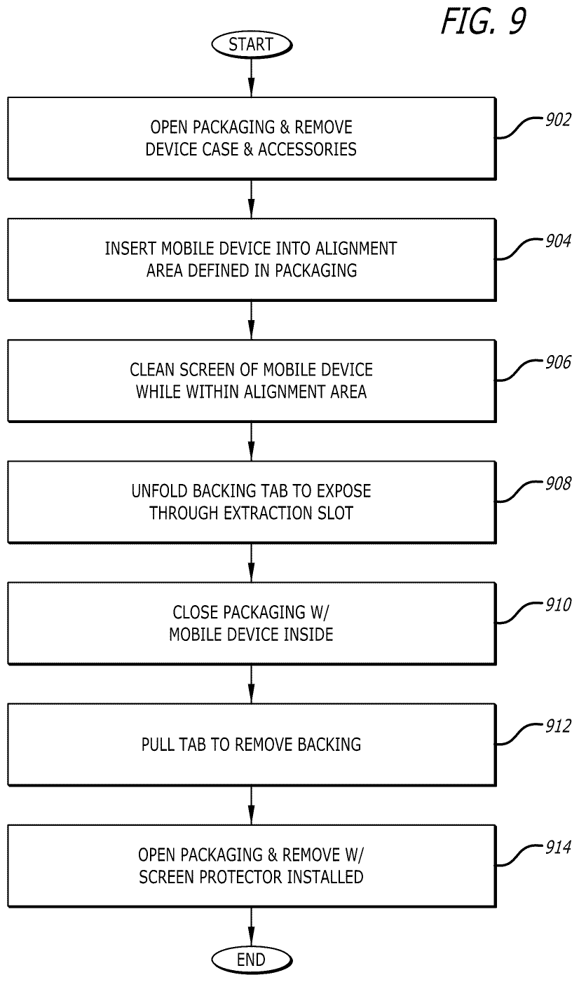

FIG. 9 is a flow diagram of installation of a screen protector according to one embodiment of the invention. At block 902, a user open packaging and removes the device case and any accessories that may be present. Some embodiments may not include accessories, but all embodiments include a device case. At block 904, the mobile device corresponding to the device case is inserted into an alignment area defined by the packaging. The alignment area is defined to snugly retain the corresponding mobile device.

Once the mobile device is within the alignment area, at block 906, the screen of the mobile device is cleaned while it remains in the alignment area. The cleaning removes grease or oils that may have accumulated on the screen from handling as well as dust or other particulates that would otherwise result in inferior adhesion of the screen protector. In some embodiments, cleaning includes using and alcohol pad to first wipe down the screen, a microfiber cloth can then be used to dry the screen and finally an adhesive sticker may be used to adhesively remove any remaining particulate matter.

At block 908, a tab coupled to a releasable backing on the adhesive screen protector is unfolded so it will extend through an extraction slot after the packaging is closed. At block 910, the packaging is closed with the device inside and the tab extending through the extraction slot. At block 912, the tab is pulled removing the backing from the adhesive film screen protector and pulling it from the packaging through the extraction slot. Finally, at block 914, the packaging is opened and the mobile device is remove with the screen protecter installed thereon.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A packaging for a case for a mobile device comprising:
a housing having a first portion and a second portion, the first portion and second portion collectively interacting to define an internal volume sufficient to contain the case;
a set of stops disposed on the first portion, the set of stops defining an alignment area dimensioned to snugly retain the mobile device; and
an adhesive screen protector for the mobile device disposed within the second portion to be in alignment with a screen of the mobile device when the mobile device is positioned in the alignment area and the first portion and second portion are in a closed configuration.

2. The packaging of claim 1 wherein the housing defines a tab slot in a end of the housing.

3. The packaging of claim 2 wherein the adhesive screen protector comprises:
an adhesive transparent film layer and
a non-adhesive releasable backing layer, the backing layer having a body at least coextensive with the film layer and a pull tab.

4. The packaging of claim 1 wherein the first portion is coupled to the second portion by a living hinge in a clam shell configuration.

5. The packaging of claim 1 wherein the alignment area is offset within the volume.

6. The packaging of claim 3 wherein the pull tab extends through the tab slot to allow the backing to be withdrawn while the first portion and the second portion are in a closed configuration.

7. The packaging of claim 1 further comprising:
a first set of alignment posts in the first portion; and
a second set of alignment posts in the second portion.

8. The packaging of claim 7 wherein the second set of alignment post define a thin neck between two shoulders, the packaging further comprising:
a carrier couple around the necks and slidable between the shoulders.

9. The packaging of claim 8 further comprising:
a resilient member coupled to the second portion and imparting a z-bias in a direction of the first portion when the packaging is in a closed configuration.

10. A method of installing a screen protector on a mobile device, the method comprising:
removing a mobile device case from a shipping packaging;
inserting the mobile device into the shipping packaging in an alignment area defined by a set of stops within the packaging;
closing the packaging with the mobile device within the alignment area;
removing a backing of the screen protector while the packaging is closed, the screen protector disposed within the packaging in alignment with the alignment area prior to packaging the device case; and
automatically adhering the screen protector to a screen of the mobile device in the alignment defined by the packaging.

11. The method of claim 10 further comprising:
cleaning the screen with alcohol in situ within the alignment area; and
drying the screen.

12. The method of claim 10 further comprising:
cleaning the screen with an adhesive member in situ within the alignment area.

13. The method of claim 10 further comprising:
exposing a tab of the backing through a slot defined in the packaging before closing the packaging; and
pulling the tab of the backing to withdraw the backing from the slot while the packaging is closed.

14. A kit comprising:
a case for a mobile device:
packaging dimensioned to contain the case, the packaging having a first portion and a second portion that collectively define a volume sufficient to contain the case, the first portion having a set of stops that collectively define an alignment area dimensioned to match the mobile device; and
a screen protector disposed within the second portion of the packaging configured to overly the alignment area when the case is in a closed orientation.

15. The kit of claim 14 further comprising:
an alcohol infused screen wipe.

16. The kit of claim 15 further comprising:
a microfiber cloth.

17. The kit of claim 14 further comprising:
an adhesive sticker.

18. The kit of claim 14 wherein the packaging define an extraction slot and wherein the screen protector comprises:
an adhesive transparent film layer and
a non-adhesive releasable backing layer, the backing layer having a body at least coextensive with the film layer and a pull tab.
